(19) United States
(12) Patent Application Publication
(10) Pub. No.: US 2016/0342570 A1
(43) Pub. Date: Nov. 24, 2016

(54) DOCUMENT PRESENTATION QUALIFIED BY CONDITIONS EVALUATED ON RENDERING

(71) Applicant: Microsoft Technology Licensing, LLC, Redmond, WA (US)

(72) Inventors: Bogdan Brinza, Seattle, WA (US); Rossen Atanassov, Bellevue, WA (US)

(21) Appl. No.: 14/727,650

(22) Filed: Jun. 1, 2015

Related U.S. Application Data
(60) Provisional application No. 62/163,331, filed on May 18, 2015.

(51) Int. Cl. G06F 17/21; G06F 17/22

(52) U.S. Cl. CPC G06F 17/212; G06F 17/2247

(57) ABSTRACT

A facility for rendering a document is described. The facility performs layout for the document. After performing layout for the document, the facility performs rendering for the document. The rendering performed by the facility for the document includes evaluating at least one condition specified in connection with authoring the document.

### CROSS REFERENCE TO RELATED APPLICATION

This application claims the benefit of U.S. Provisional Application No. 62/163,331, filed May 18, 2015, and entitled “DOCUMENT FRAGMENTS QUALIFIED BY CONDITIONS EVALUATED ON RENDERING,” which is incorporated herein in its entirety by reference.

### BACKGROUND

Modern browsers use a multi-stage document processing pipeline to transform a representation of a web page or other document made up of a markup language document (e.g., a document expressed in HyperText Markup Language (“HTML”), eXtensible Markup Language (“XML”), eXtensible Application Markup Language (“XAML”), and/or Scalable Vector Graphics (“SVG”) and a formatting resource (e.g., a Cascading Style Sheet (“CSS”)) into a visual representation of the document shown on a display device.

In conventional ones of such browsers, visual presentation logic responsive to conditions under which the document will be displayed is evaluated at an early stage of the document processing pipeline, such as when a deserialized version of the formatting resource (e.g., a Cascading Style Sheet Object Model) is generated from the formatting resource. Such “formatting-time” conditions are expressed in terms of logical pixels used to do browser layout; logical pixels are sometimes called “CSS pixels,” and differ from the physical pixels of the display device with respect to which the final visual representation of the document is ultimately generated. For example, a formatting-time condition based on a CSS @media query can cause a formatting rule, such as one to establish a particular background color, to be applied only if the width of the browser window is no more than 400 CSS pixels (“400 px”).

### BRIEF DESCRIPTION OF THE DRAWINGS

FIG. 1 is a block diagram showing some of the components typically incorporated in at least some of the computer systems and other devices on which the facility operates.

FIG. 2 is a data flow diagram showing a sample document render pipeline in connection with which the facility operates in some examples.

FIG. 3 is a flow diagram showing a sample process performed by the facility in some examples to render a document having render-time conditions.

FIG. 4 is a display diagram showing the rendering of the sample document in a first state.

FIG. 5 is a display diagram showing the rendering of the sample document in a second state.

SUMMARY

This summary is provided to introduce a selection of concepts in a simplified form that are further described below in the Detailed Description. This summary is not intended to identify key factors or essential features of the claimed subject matter, nor is it intended to be used to limit the scope of the claimed subject matter.

A facility for rendering a document is described. The facility performs layout for the document. After performing layout for the document, the facility performs rendering for the document. The rendering performed by the facility for the document includes evaluating at least one condition specified in connection with authoring the document.

### DETAILED DESCRIPTION

The inventors have recognized that the conventional approach of evaluating visual presentation logic early in the document processing pipeline—such as at formatting-time—has significant disadvantages. A first disadvantage is that if, during display of the rendered document, state changes in such a way as to alter satisfaction of one of the conditions, a significant portion of the document processing pipeline must be repeated for the document to reflect the change in satisfaction of the condition, which can consume considerable processing resources, and/or introduce significant latency in reflecting the change in the rendered document. For example, a change in the width of the browser window can alter satisfaction of a condition that is based on the width of the browser window.

A second disadvantage is that, early in the document processing pipeline, dimensions of the document and its contents are expressed exclusively in terms of CSS pixels, making it impossible to at that point in the pipeline compare such dimensions to dimensions expressed in physical pixels.

In order to overcome the disadvantages discussed above, the inventors have conceived and reduced to practice a software and/or hardware facility (“the facility”) for including conditions with respect to a document that are evaluated upon rendering of the document. In various examples, these can be conditions that determine whether document fragments are included in the visual representation generated for the document as well as conditions that determine whether particular formatting attributes are applied to particular document fragments. These conditions can compare dimensions within the document to numbers of physical pixels specified in the conditions.

In some examples, the facility permits conditions that involve comparisons of dimensions expressed in physical pixels to be imposed on groups of formatting attributes specified for styles, such as CSS styles, established for various classes of markup entities and their corresponding display fragments.

For example, in a document where a background image is to be included only when display of the document is zoomed in, the visualization of the background image is conditioned on the zoom level being greater than a threshold level.

In some examples, the facility implements such conditions on visualization of a fragment by establishing a non-display formatting attribute in a style specified for the class to which the fragment corresponds where the non-display attribute is established subject to a condition that is the logical inverse of the condition for including the fragment. Here, a non-display attribute for a class corresponding to the image can be conditioned on the physical window width being smaller than a threshold number of physical pixels, while a non-display attribute for a class corresponding to the text can be conditioned on the physical window width being larger than or equal to the threshold number of physical pixels. If, during display of the document, a user alters the window size in such a way that its physical width passes the threshold number of physical pixels, the non-display attributes are inverted between the display fragments corresponding to the two classes at the rendering stage, causing the text and image to be exchanged.

As another example, a document containing a cartographic map may be designed to be responsive to a user-controlled zoom level. For each available zoom level, a set of map tiles corresponding to the zoom level adequate to fill the a map region of the window can be included, subject to a condition that the current zoom level corresponds to the zoom level of the tiles. At render time, only the set of tiles corresponding to the current zoom level is visualized. If, during display of the document, a user alters the zoom level, a different set of tiles corresponding to the new zoom level is visualized at the rendering stage.

As a further example, in a document containing a schematic diagram, conditions can be included that prevent lines making up the diagram within a bounded range of thicknesses between 1 physical pixel and 10 physical pixels.

By evaluating these conditions during the rendering stage of the render pipeline, the facility (1) makes it possible to impose conditions expressed in terms of dimensions measured in physical pixels, so that the conditions can address the way the document is displayed on the display device, and (2) can respond to state changes that alter the outcome of conditions in an efficient way that obviates repeating significant portions of the render pipeline processing.

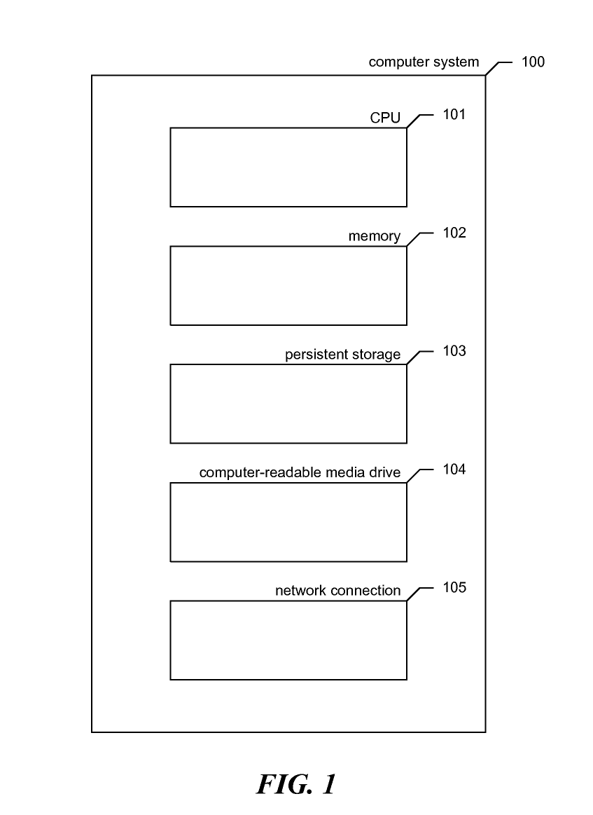

FIG. 1 is a block diagram showing some of the components typically incorporated in at least some of the computer systems and other devices on which the facility operates. In various examples, these computer systems and other devices 100 can include server computer systems, desktop computer systems, laptop computer systems, netbooks, mobile phones, personal digital assistants, televisions, cameras, automobile computers, electronic media players, etc. In various examples, the computer systems and devices include zero or more of each of the following: a central processing unit (“CPU”) 101 for executing computer programs; a computer memory 102 for storing programs and data while they are being used, including the facility and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations, and having various components.

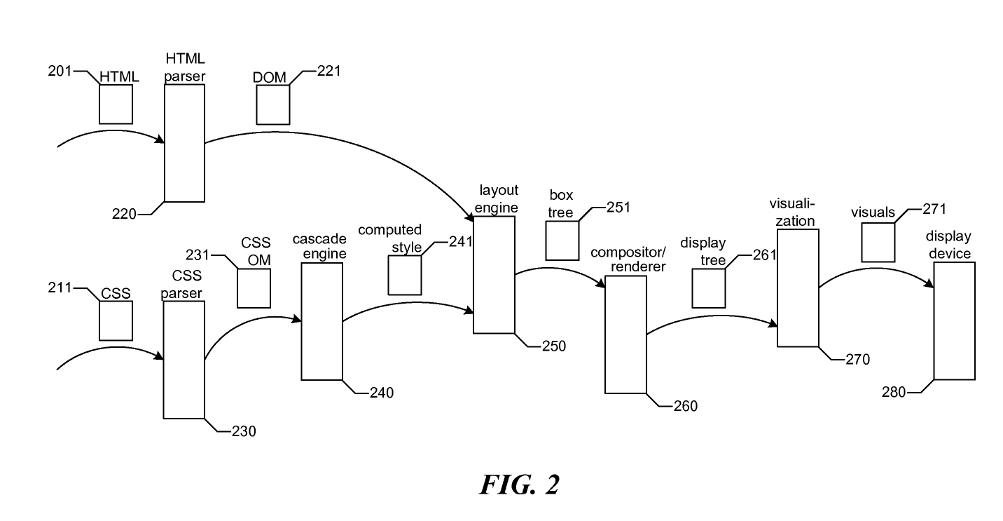

FIG. 2 is a data flow diagram showing a sample document render pipeline in connection with which the facility operates in some examples. The pipeline receives HTML 201 defining content of a document or other document and CSS 211 defining formatting to be applied to the content, in some cases from a web browser download manager, which retrieves it from a remote web server. In some examples, the HTML and corresponding CSS are distributed across a different number of files, such as being contained in the same file, such as being contained across a larger number of files than two, etc. An HTML parser 220 parses the HTML to produce a deserialized tree data structure representing its contents called the Document Object Model (“DOM”) 221, while similarly a CSS parser 230 parses the CSS to obtain a deserialized tree data structure called a Cascading Style Sheet Object Model (“CSSOM”) 231. The CSS can contain any number of render-time conditions on formatting attributes. A cascade engine 240 processes the CSSOM to produce one or more computed styles 241. A layout engine 250 processes the DOM and computed style in order to generate a box tree 251 representing the application of appropriate styles from among the computed styles to elements of the DOM. This includes creating dimensions and coordinates for various fragments in the box tree corresponding to elements in the HTML, in each case in terms of CSS pixels, which have no necessary relationship to the physical pixels of the display device on which the document will be presented. A compositor/renderer 260 processes the box tree to generate a display tree, in which fragments are present corresponding to all of the elements in the HTML, in some cases qualified based upon conditions specified in the CSS. The coordinates and dimensions expressed in the box tree with respect to CSS pixels are expressed in the display tree with respect to display pixels. Also, various other distance measures are available at this point in the pipeline in terms of physical pixels, including display device width and height, window width and height, etc. As part of the visualization process 270, all of the conditions in the display tree are evaluated, and visuals are generated from the portions of the display tree that are either unqualified by conditions or qualified by true conditions, to the exclusion of those that are qualified by false conditions. These visuals 271 are directed to a display device 280, where they are presented. The visuals can comprise bitmaps, physical pixel coordinate-based drawing instructions, etc.

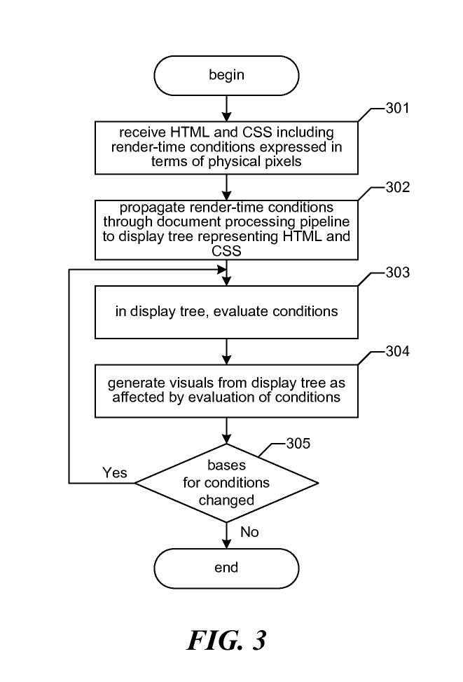

FIG. 3 is a flow diagram showing a sample process performed by the facility in some examples to render a document having render-time conditions. At 301, the facility receives HTML and CSS including render-time conditions expressed in terms of physical pixels. At 302, the facility propagates those render-time conditions through the document processing pipeline to a display tree data structure representing HTML and CSS as processes in the pipeline. At 303, in the display tree, the facility evaluates the conditions. In step 304, the facility generates visuals from the display tree in a way that is affected by evaluation of conditions; that is, by including fragments and other elements unqualified by conditions and those qualified by true conditions, and excluding fragments and other elements qualified by false conditions. At 305, if any bases for the conditions change, then the facility continues at 303 to reevaluate the conditions. After 305, this process concludes.

Those skilled in the art will appreciate that the steps shown in FIG. 3 and in each of the flow diagrams discussed below may be altered in a variety of ways. For example, the order of the steps may be rearranged; some steps may be performed in parallel; shown steps may be omitted, or other steps may be included; a shown step may be divided into substeps, or multiple shown steps may be combined into a single step, etc.

Table 1 below contains sample source code for a sample document rendered by the facility in some examples.

```
TABLE 1
  1 <!doctype html>
  2 <html>
  3 <head>
  4 <title>CSS Render Query Example</title>
  5 <style>
  6
  7 /* Queries that will get evaluated during rendering */
  8 .state @render(zoom <= 0.5) {
  9 background: none;
                    /* no visible border when zoom out */
10 }
11 .state @render(zoom > 0.5) {
12 background: url(stateborder.jpg);
/* visible border on normal zoom */
13 }
14 </style>
15 </head>
16 <body>
17 <h2>Expected: state border visible on normal
zoom and not visible when zoomed out.</h2>
18 <div class=“state”>WASHINGTON</div>
19 <div class=“year”>1889</div>
20 </body>
21 </html>
```

Lines 1-21 define the document. Lines 5-14 specify CSS formatting information. In particular, lines 8-12 define a style for an “state” class of elements. This class definition contains two render-time conditions for determining whether elements of the state class have a background. The first render-time condition on line 8 is satisfied where the zoom level is relatively low, reflecting that display of the document is zoomed relatively far out. Where this condition is satisfied, elements of the state class have no background. The second render-time condition on line 11 is satisfied where the zoom level is relatively high, reflecting that display of the document is zoomed in relatively far. Where this condition is satisfied, elements of the state class have a background corresponding to an image containing a state border. In line 18, an element made up of the text “WASHINGTON” is attributed the state class. Accordingly, this element will have the specified image as a border when the document is zoomed in relatively far, and won't have a border when the document is zoomed out relatively far.

In various embodiments, the facility supports the use of a variety of measures in its render-time conditions including, for example, fragment width, fragment height, window width, window height, device width, device height, device orientation, device aspect ratio, device pixel ratio, zoom factor, and transforms.

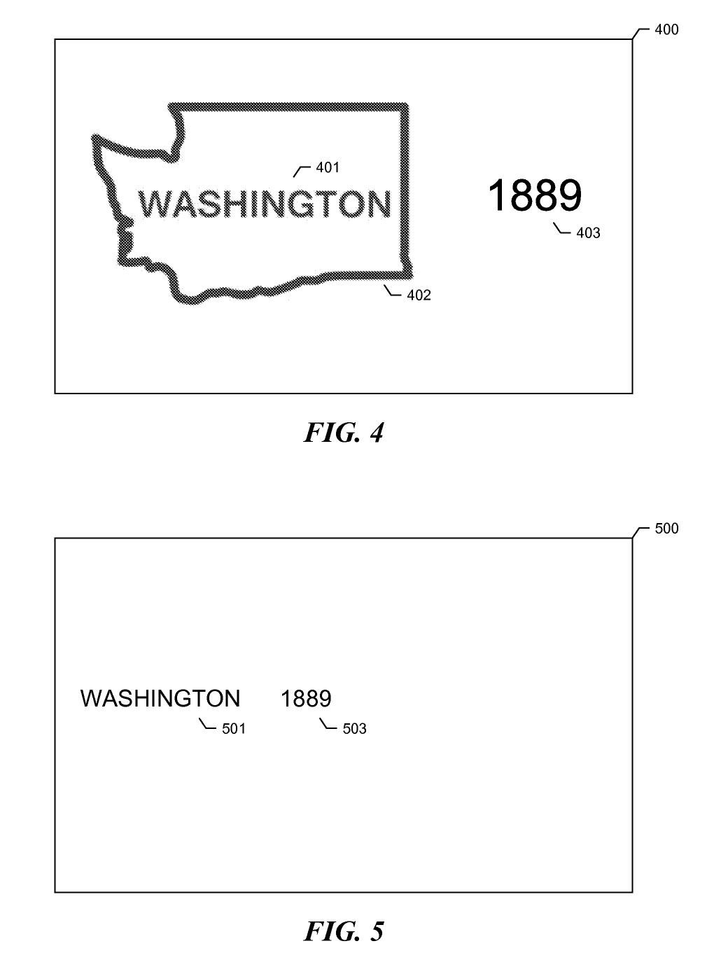

FIG. 4 is a display diagram showing the rendering of the sample document in a first state. The device has a display area 400 in which the sample document is displayed. In FIG. 4, the zoom level is relatively high, and greater than 0.5. It can be seen that, within the display area, the “WASHINGTON” element 401 is displayed with a state border image 402 as its background in response to the zoom level being relatively high. The user can adjust the zoom level, such as by using a touchscreen pinch gesture, using a mouse scroll wheel input technique, typing a new numeric zoom level into a field, etc.

FIG. 5 is a display diagram showing the rendering of the sample document in a second state. In the second state, the user has reduced the zoom level in order to zoom out relative to FIG. 4. In response, the facility has reevaluated the conditions in the display tree to determine that the zoom level is now below the 0.5 zoom level threshold. Accordingly, the satisfaction of the two conditions is reversed, and the border image 402 is removed from the “WASHINGTON” element 501.

In some examples, a computer-readable medium having contents adapted to cause a computing system to perform a process for rendering a document is provided. The process comprises: performing layout for the document; and after performing layout for the document, performing rendering for the document, wherein performing rendering for the document comprises evaluating at least one condition specified in connection with authoring the document.

In some examples, a computing system adapted to render a document is provided. The computing system comprises: a layout engine configured to perform layout for the document; and a renderer configured to, after the layout engine performs layout for the document, perform rendering for the document, wherein the rendering performed for the document by the renderer comprises evaluating at least one condition specified in connection with authoring the document.

In some examples, a computer-readable medium storing a data structure is provided. The data structure comprises: one or more entries each corresponding to a style for displayable fragments, each entry at least one style attribute, each of at least one of the entries specifying, for a selected one or more its style attributes, an application condition specified on the application of the selected style attributes, the application condition being expressed in terms of a number of pixels of a physical display device on which displayable fragments are to be displayed, such that the contents of the data structure are usable to determine whether each of the selected style attributes should be applied to displayable fragments.

It will be appreciated by those skilled in the art that the above-described facility may be straightforwardly adapted or extended in various ways. While the foregoing description makes reference to particular approaches to implementation, the scope of the invention is defined solely by the claims that follow and the elements recited therein.

1. A computing system configured to render a document, the computing system comprising:
a layout engine configured to perform layout for the document; and
a renderer configured to, after the layout engine performs layout for the document, perform rendering for the document,
wherein the rendering performed for the document by the renderer comprises evaluating at least one condition specified in connection with authoring the document.

2. The computing system of claim 1 wherein the document is a web page.

3. The computing system of claim 1 wherein performing layout comprises determining coordinates and dimensions of displayable portions of the document in terms of logical pixels,
and wherein performing rendering for the document comprises determining coordinates and dimensions of displayable portions of the document in terms of physical pixels, and wherein at least one of the at least one evaluated condition is expressed in terms of physical pixels.

4. The computing system of claim 1 wherein at least one of the at least one evaluated condition qualifies application of a selected style attribute to a displayable portion of the document.

5. The computing system of claim 4 wherein application of the selected style attribute controls whether a corresponding displayable portion of the document will be included in visuals produced for the document.

6. The computing system of claim 4 wherein application of the selected style attribute controls a manner in which a corresponding displayable portion of the document will be included in visuals produced for the document.

7. The computing system of claim 1 wherein the at least one condition specified in connection with authoring the document is contained in a style resource identified for application to the document.

8. A computer-readable medium having contents configured to cause a computing system to, in order to render a document:
perform layout for the document; and
after performing layout for the document, perform rendering for the document, performing rendering for the document comprising evaluating at least one condition specified in connection with authoring the document.

9. The computer-readable medium of claim 8 wherein the document is a web page.

10. The computer-readable medium of claim 8 wherein performing layout comprises determining coordinates and dimensions of displayable portions of the document in terms of logical pixels,
and wherein performing rendering for the document comprises determining coordinates and dimensions of displayable portions of the document in terms of physical pixels,
and wherein at least one of the at least one evaluated condition is expressed in terms of physical pixels.

11. The computer-readable medium of claim 8 wherein at least one of the at least one evaluated condition qualifies application of a selected style attribute to a displayable portion of the document.

12. The computer-readable medium of claim 11 wherein application of the selected style attribute controls whether a corresponding displayable portion of the document will be included in visuals produced for the document.

13. The computer-readable medium of claim 11 wherein application of the selected style attribute controls a manner in which a corresponding displayable portion of the document will be included in visuals produced for the document.

14. The computer-readable medium of claim 8 wherein evaluating at least one condition specified in connection with authoring the document is contained in a cascading style sheet identified for application to the document.

15. A computer-readable medium storing a data structure, the data structure comprising:
one or more entries each corresponding to a style for displayable fragments, each entry having at least one style attribute, each of at least one of the entries specifying, for a selected one or more its style attributes, an application condition specified on the application of the selected style attributes, the application condition being expressed in terms of a number of pixels of a physical display device on which displayable fragments are to be displayed,
such that the contents of the data structure are usable to determine whether each of the selected style attributes are to be applied to displayable fragments.

16. The computer-readable medium of claim 15 wherein the application conditions each specify comparison of a dynamic quantity to the number of pixels of a physical display device.

17. The computer-readable medium of claim 15 wherein the data structure is a CSS block.

18. The computer-readable medium of claim 17 wherein at least one of the selected style attributes is “display: none”.

19. The computer-readable medium of claim 15 wherein the data structure is a display tree.
